(19) United States
(12) Patent Application Publication
(10) Pub. No.: US 2021/0209198 A1
(43) Pub. Date: Jul. 8, 2021

(54) APPARATUS AND METHOD FOR FRAND LICENSING AND TRANSACTION COSTS FOR MORE INDIVIDUAL LICENSE AGREEMENTS THROUGH SMART CONTRACTS ON THE BASIS OF BLOCKCHAIN TECHNOLOGY

(71) Applicant: JONAS BLOCK, DUSSELDORF (DE)

(72) Inventor: JONAS BLOCK, DUSSELDORF (DE)

(21) Appl. No.: 17/124,425

(22) Filed: Dec. 16, 2020

Related U.S. Application Data
(63) Continuation of application No. 17/124,299, filed on Dec. 16, 2020.
(60) Provisional application No. 62/949,395, filed on Dec. 17, 2019.
(60) Provisional application No. 63/019,070, filed on May 1, 2020.

(51) Int. Cl. G06F 21/10; G06Q 50/18; G06Q 20/12; G06Q 40/06

(52) U.S. Cl. CPC G06F 21/105; G06Q 50/188; G06Q 2220/18; G06Q 40/06; G06Q 20/1235

(57) ABSTRACT

The present invention is a self-executing FRAND licensing method and system incorporating partially software-supported and automated contract design and administration, resulting in lower transaction costs, more individual and flexible licensing models, and improved contract management by use of smart contracts. Smart contracts use algorithms for automatic execution via a processing unit when a required event occurs. Licensing terms and information is continuously updated, categorized and stored in a database that is connected to the processing unit. The processing unit recognizes and evaluates changes and in turn executes the contractual result for the respective case. The data required for the execution of the license agreements could be documented by using blockchain technology in a peer to peer arrangement. Automated licenses are transferred to individual patent registers into a uniform digital file format merged into a worldwide register. Automated contract design is combined with secure blockchain data storage, and a continuous, value-based top-down approach. Comparative licenses can be used in addition to checking the license fees calculated by valuation algorithms in individual cases.

### PRIORITY CLAIMS

This application is a continuation of U.S. patent application Ser. No. 17/124,299, filed on Dec. 16, 2020, which claims the benefit of U.S. Provisional Application Ser. No. 62/949,395, filed on Dec. 17, 2019, and U.S. Provisional Application Ser. No. 63/019,070, filed on May 1, 2020, the contents of which are incorporated herein.

### BACKGROUND OF THE INVENTION

Every exchange of assets entails transaction costs. The transaction costs burden the exchange ratio and in unregulated markets—in addition to the targeted profit—are added to the production price of the exchanged asset, i.e. “priced in”. Transaction costs are also incurred for license agreements for industrial property rights and are charged to the license fee demanded by the owner of the industrial property right. Due to the principle of contractual autonomy, the importance of transaction costs in unregulated license agreements is limited. The property right owner creates an offer that is either economically attractive for the license seeker—or not. Anyone applying for a license to a patent will, for example, include in his assessment the costs of alternative technical solutions outside the scope of protection of the patent offered for the license and consider whether it is more favourable to take a license, to develop and establish a technical solution of one's own on the market or to switch to a technical solution in the public domain.

The situation is fundamentally different where the potential licensee cannot rely on alternative or public service technical solutions, since, due to a lack of demand, he cannot effectively market a competitive product on the market with these solutions. If the license seeker wants to create a marketable offer, he must conclude a license agreement.

Such an initial situation exists, for example, in standardised technology areas with a view to those patents in whose scope of protection it is mandatory to intervene if the standardised teaching on technical action is to be implemented, so-called standard essential patents (in short: essential patents or SEP). In order to ensure that interested third parties can also gain access to the standardized result of standardization, the holders of essential patents are obliged under antitrust law to grant licenses to their essential patents on fair, reasonable and non-discriminatory terms, in short: FRAND terms.

If a property right has to be licensed on a massive scale, it would be a good idea to draw up a standard license agreement and use it consistently. The antitrust dimension of the licensing of essential patents, however, requires—at least according to recent case law—that the licensor deals transparently with the circumstances of the individual case, thus addressing in particular its economic background. Alternatively, the licensor may compensate for an “unreasonable level of royalties by other mechanisms” in individual cases, e.g. if he unilaterally bears the risk of economic undercompensation. The licensor is faced with the decision either to use a standard license agreement and to realise low license fees throughout the country or to offer individualised, flexible license agreements in individual cases. However, the additional economic effort required to monitor and execute individualised and flexible license agreements then charges the license fee charged by the licensee as transaction costs.

The paradigm shift in case law following the decision of the European Court of Justice in the Huawei v ZTE case has led to the fact that the licensing practice which has been practised to date, has increasingly been perceived by courts over the past two years as too imprecise. The required changes in SEP holder licensing practices will result in higher transaction costs. If the derivation of the license fee is to become more transparent for the license seeker, less flat-rate factors must be included in the calculation of the license fee. Then, the circumstances of the individual case must be determined and assessed. This expenditure of time and resources is transaction expenditure.

The object is to examine how the transaction costs for the conclusion and administration of license agreements for essential patents or entire portfolios of essential patents can be reduced, so that even under the changed requirements of case law essential patents can be licensed out so economically that the standardized technology areas remain attractive for investments in research and development (R&D investments). A decisive criterion for this is the unconditional focus on patent quality as a central aspect of patent evaluation. In practice, only high-quality, legally valid patents are respected and the willingness to license patent portfolios decreases dramatically with decreasing patent quality. The transaction costs incurred for the (continuous) determination of patent quality must be at least balanced against the savings resulting from the elimination of worthless patents in order for a license offer to be economically attractive at all. No commercial licensee will be prepared in the licensing reality to pay higher royalties than for a flat-rate license only to obtain a license tailored to his individual commercial needs.

### SUMMARY OF THE INVENTION

The risk of higher transaction costs, which could erode the savings, can be countered by a self-executing FRAND licensing mechanism. If the contract design and administration is at least partially software-supported and automated, transaction costs are considerably lower.

Automation is particularly worthwhile when certain processes are carried out in large numbers and impersonally, i.e. independently of the persons involved. Typically, license agreements are not a mass business. In the case of license agreements on standard essential patents, however, the rule-exceptional relationship is reversed. Due to the FRAND access, the SEP holder is obliged to conclude a license under FRAND conditions with each license seeker. In the case of the MPEG license pool, the pool members have greatly simplified access to the protected technology by offering each license seeker a standard license agreement on uniform and unalterable terms. The standard license agreement for the MPEG-2 video coding standard, for example, has already been concluded 942 times with the same content, almost 1,400 times for the MPEG-4 standard and 262 times for the successor standard HEVC.

These figures show that SEP licensing is also a mass business and therefore more suitable for automation than licensing contracts for non-standard IP rights. The freedom in the choice of the contracting party is considerably restricted by the antitrust access obligation, so that the conclusion of the contract does not require a relationship of trust between the contracting parties. At the same time, the prohibition of discrimination sets narrow limits on the content of potential deviations and the obligation of transparency in the calculation of licenses can be established by means of visible calculation data.

Self-executing contracts could make contract management more effective. With low transaction costs, more individual and flexible licensing models could be offered, taking into account the increased requirements of case law.

For the processing unit to be able to read and execute the contract terms, the contract text (human-readable source text) must be converted into machine-readable code (machine code). For this purpose, the Smart Contract is formulated on the software level according to the syntax of a certain programming language as a bundle of different instructions that can be processed by the processing unit (so-called program code). The formal sequence and the systematics, according to which the processing unit is to implement the instructions provided in the program code in the concrete application case, is called algorithm.

In the simplest variant of Smart Contracts, the algorithm describes certain transactions that the processing unit automatically executes if it [the processing unit] is proved that a certain condition has occurred (the so-called if-then rule). This means that fixed activities to carry out the expression of will of the contract are automatically carried out when a required event occurs. At the same time, all contractual partners shall be informed of status changes in real time.

For the processing unit to be able to verify whether one of the predetermined conditions has occurred, it is dependent on evaluable information. This information is categorized and stored in a database that is continuously updated and connected to the processing unit. The processing unit can recognize and evaluate changes in the information situation and execute the contractual reaction for the respective case. In order for the reaction to be automated, too, interfaces must be provided for external reactions, e.g. for the collection or payment of a sum of money, such as license fees from the licensee to the licensor or annual fees to an office. The reactions are preferably used within the system in order to further integrate the system, for example by updating or modifying a data field in the database; e.g. specifying a factor in a calculation complex.

The data required for the execution of the license agreements could be documented in a block chain. Blockchain technology is based on the principle that transactions are combined and validated in a chain of blocks that build on each other. The central advantage of blockchain technology over other data security systems is its extremely low susceptibility to manipulation. The blockchain technology operates decentrally and does not require a central memory or control unit(s), i.e. from a safety point of view no single point of failure.

Considering these technological peculiarities of blockchain technology, it can meet the high demands to be made on an evidence preservation mechanism that forms and updates the test basis for self-executing contracts.

The level of detail and thus the individual fairness made possible by self-executing contracts and artificial intelligence depends to a large extent on the size of the database to which the evaluation algorithm has access. In order to create a technical environment in which self-executing contracts can work precisely, the relevant information must be machine-readable and, if possible, transferred to a uniform database. The following applies here: the more information is available for the calculations, the greater the networking effect of the information among each other and the more precise the ejected results of the automated information processing.

In an optimal case, all information is available to the system, i.e. it is fully integrated and does not have to price in uncertainties or evaluate and integrate external factors. Of course, no information technology system is so perfect. Nevertheless, all information technology systems strive for this optimal state, since it puts them in a position to operate as autonomously as possible.

A basic task for automated licenses is to transfer the national patent registers into a uniform digital file format and to merge them into a worldwide register that represents the absolute number of intellectual property rights worldwide. In a second step, the global register database must be compared with the databases of the standardization organizations. To date, the standardisation organisations have maintained their own databases for essentiality reports and FRAND declarations of commitment. Not all databases are publicly accessible.

The resulting central global register thus contains all register data on all patents worldwide. On this basis, simpler transactions such as patent transfers or the payment of annual fees can be automated. In order to automate entire license agreements, especially for essential patent portfolios, further data is required. The data records required for this should also be stored in a block chain if they have been identified as necessary and entered, in order to avoid system breaks. If these data are confidential trade secrets of a company involved in a transaction, a (possibly parallel) non-public blockchain could be maintained as backup and supplementary storage.

In order for a self-executing pricing algorithm to be able to charge the license seeker a fair and reasonable royalty, which is non-discriminatory in the context of existing licenses, certain basic decisions need to be taken and the factors for pricing determined. A worldwide patent database provides important objective information on the territorial spread, weighting and residual maturity of the SEP assigned to a standard as well as on its holder and the size of the portfolio belonging to the standard. The negotiating parties quickly receive precise background information, which they can incorporate into pricing. If the automated FRAND license offer and the automatically administered FRAND license agreement are to provide added value in terms of content compared to the weighted FTO currently granted, both the “time” and “license territory” factors need to be addressed in more detail. According to current practice, these aspects are only two of many negotiating factors for the contract offer on the basis of a worldwide mixed calculation during the duration of the contract.

The contractual linchpin of the automated FRAND license agreement offer is the time of the licensing request. From this moment on, the forward-looking license fee and—if necessary—the backward-looking amount of damages can be calculated. For this purpose, all calculation-relevant values, insofar as they are subject to the temporal change, are recorded in a “snapshot” (snapshot, evaluation snapshot) at the time of the licensing request. In information technology, this refers to the snapshot of a global state in a changing system at a particular point in time. By combining automated contract design with forgery-proof storage in a blockchain, the aim of this thesis is to save data and computing time by gradually taking snapshots, so-called incremental snapshots. Because every snapshot captured by the system and stored in the blockchain captures the global state of the system. This means that the complete evaluation process does not have to be completed every time, but it is sufficient for the system to update the last stored snapshot and only calculate the changes from the previous state using the algorithm. Of course, the system should carry out regular security cross-checks by parallel and complete recalculations on the basis of a current snapshot. This allows the system to reassure itself that the pricing algorithm is working correctly and precisely and also avoids redundancies.

The time interval for the valuation of the SEP portfolios relevant for a standard can be set at will. The smallest time unit for the evaluation is the day, since the term of protection of a patent is exactly twenty years to the day since the filing date. Although a daily assessment is possible, it is extremely resource-intensive, as changes in the worldwide intellectual property rights portfolio must be tracked on a daily basis. For practical reasons, a monthly or quarterly update is recommended.

The offered license fee is a legal snapshot, as it is based on the time interval of the evaluation. For example, if the global rating is updated monthly, the license fee offered will change from month to month. After a successful conclusion of the license agreement, the agreed license fee is determined for each time interval and is thus continuously updated within the framework of license management. In principle, it seems possible that the parties to the agreement are free to choose the update interval—provided that this does not result in price discrimination in practice, especially in the case of different agreements with comparable licensees.

This approach makes the costs of the license fee transparent to the licensee at all times and documents them (using a blockchain). In addition to the offer of the license for the future, the offer could include provisions for the remuneration of past acts of use. The license seeker knows from his books in which period of time and to what extent he has carried out activities subject to remuneration. If he informs the SEP holder of this data—while maintaining the necessary confidentiality—the exact amount of the compensation payment can be determined.

In order to enable individualisation in individual cases, both the territorial extension of the licensed portfolio and the territorial dimension of the licensee's acts of use must therefore be set in relation to each other. Different degrees of detail are conceivable: The attempt to record the territorial relation of the license per actual act of use, i.e. for every manufactured and distributed end product, is an immense challenge and causes a very considerable effort. The worldwide distribution channels and value chains would have to be recorded daily and for several hundred million products in parallel. The task seems technically feasible in principle, but the costs of its realisation are currently still far higher than its financial benefit.

Alternatively, certain territorial zones could be provided to take account of territorial portfolio coverage and, where appropriate, regional price differentials. In TCL v Ericsson, for example, Judge Selna has defined three zones with different license rates: the USA, Europe and the rest of the world (RoW). Justice Birss also differentiated Unwired Planet v Huawei regionally into “major markets” and “other markets”.

In order to create a consistent licensing program, the reference value for the license, the manner in which it is billed, and finally the valuation approach must be fundamentally defined and coordinated.

A decisive factor for a consistent licensing program is the selection of the correct reference value for the FRAND license and the subsequent question of how the reference value is to be reflected in the valuation approach.

The choice of the subject matter of the license or the reference value is of decisive importance in FRAND licensing. A uniform reference value makes it easier for the SEP holder to address a FRAND offer to the value chain. The companies that make up the value chain are very familiar with the conditions customary in the industry and the contractual terms of delivery in their respective markets. If the royalty is not allocated proportionately to the participating companies on the basis of the value added shares, but is simply priced in uniformly at all levels, it is actually a transitory item within the meaning of tax law and thus neutral to profits.

A unit license makes it easy to calculate and track the license fees owed. At the same time, they remain more accurate than flat-rate licenses, as the license volume will continue to be tracked concretely. Until the information technology systems have been integrated and matured to such an extent that they can determine a percentage quota license quickly and at low transaction costs, the calculation mechanism proposed should therefore not be linked to the specific reference figure for each individual case, but should be based as a unit license on a uniform license fee basis for all comparable standard-compliant end products.

Once the reference value of the license and its accounting method have been determined, the question arises as to the choice of the valuation approach to be applied. In practice, two fundamentally different evaluation approaches are discussed: the so-called bottom-up approach and the so-called top-down approach. As their names already indicate, the valuation approaches differ primarily in terms of the total number of standard essential patents.

According to the top-down approach, the maximum license burden is first determined for the entire standard (T) and then distributed on a value basis among the patent portfolios (S) essential for the standard (TxS). The perspective of the evaluation is based on the entire standard. By using exponential IT analysis methods—such as artificial intelligence—all patents declared essential for a standard can be tested for their actual legal validity, their actual standard essentiality and thus for their actual value. This concept enables a “holistic” and continuous, value-based top-down view with moderate to low transaction costs. Comparative licenses can —especially in the initial phase of a valuation system operating in this way—be used in addition to checking the license fees calculated by the valuation algorithm in individual cases.

A uniform average royalty basis should be provided as a reference for all FRAND licenses for an asset with a particular quality or within a particular product or service category. This license fee basis is fictitious because it is based on a mixed calculation and is universally applicable—e.g. uniform license fee basis for a 3G multimode smartphone: 300 EUR or for a luxury car with 3G multimode functionality: 50,000 EUR. The net retail price will have to be used to determine the global royalty base, as wholesale prices would not require remuneration of the margin of the final distributor.

Once the value of the reference value has been determined, the maximum license charge for standardbound IP rights must be determined and updated, e.g. by a specialist committee respected by the market.

Finally, it has to be examined what share the technical standard, for which the patents to be licensed are essential, has in the total load share—and thus indirectly in the end device price. This is the value in which the licensed SEP ultimately participates under the top-down approach. The significance of the “technical functionalities provided by the individual standards for the successful sale of an end product in the downstream product market in relation to each other” will also be decisive for this.

This approach could be fruitful for a top-down approach to create incentives for SEP holders to invest in quality rather than quantity.

### BRIEF DESCRIPTION OF THE DRAWINGS

FIGS. 1A-1B are an exemplary calculation method of the present invention.

FIGS. 2A-2B are an exemplary calculation method of the present invention.

### DETAILED DESCRIPTION OF THE PREFERRED EMBODIMENT

Since it is extremely difficult to measure the added value the standard creates compared to alternatives or predecessor technologies (e.g. faster random access, lower latencies, larger transmission capacities, etc.), more valuable patent portfolios should receive a higher share of the absolute standard license “V_{[STANDARD]-All}”. If the SEP holder can access additional financial resources through higher average quality, he will have an entrepreneurial incentive for R&D activities and contributions to standardisation processes. In this way, the phenomenon of deliberate over-declaration for negotiation purposes (leverage) can be reduced. A smaller total number of high-quality patents also reduces the examination effort and in turn has a positive effect on the transaction cost burden.

The proportional value of the standard “V_{[STANDARD]-All}” in the device value is thus to be divided into two parts for which different valuation approaches can be used: a basic value and a corridor value.

In an exemplary calculation method, the base unit value is expressed as ‘T_{[STANDARD] GA}’ and the corridor unit value as ‘T_{[STANDARD]-KA}’. The value of a SEP (VSEP) is therefore divided into the values Share of the underlying value (SEP-VGA) and a share of the corridor value (SEP-VKA) calculated on the basis of portfolio membership.

I.e. the value of a SEP (VSEP) is SEP-VGA+SEP-VKA.

The Absolute Standard License is the share of V_{[STANDARD]-All} in the total burden VGLB and thus represents the value share of all patents reported as essential for a certain technical standard (S_{[STANDARD]-All}) in the average terminal equipment value _{VDGW} at a certain valuation date. The Absolute Standard License V_{[STANDARD]-All} is distributed among the patents contained in the sum S_{[STANDARD]-All}.

The first step is to determine the total license charge (VGLB), expressed in one currency, that can be assigned to an average terminal device. For this purpose, the average terminal equipment value (_{VDGW}) is multiplied by the total share factor, a value between 0 and 1. The total license burden (VGLB) is the total economic burden of the average terminal with licenses for essential patents.

In a second step, the value ratios of the technical standards contained in the total license burden (VGLB) must be clarified. For this purpose, each standard contains the standard share factor. Multiplying the Total License Expense Value (VGLB) determined after step 1 by a standard share factor b between 0 and 1 to obtain the Absolute Standard License Value (V_{[STANDARD]-All}) expressed in one currency. In a nutshell: _{VDGW}×a×b=V_{[STANDARD]-All} The Absolute Standard License (V_{[STANDARD]-All}) is the total economic burden of the average terminal with licenses for essential patents belonging to a particular standard.

The value V_{[STANDARD]-All} for the Absolute Standard License must then be divided into the base unit value V_{[STANDARD]-GA} and the corridor unit value V_{[STANDARD]-KA}. The value ratio of the corridor share (V_{[STANDARD]-KA}) is consequently determined by the importance of the licensed technology for the relevant reference value, as expressed by the total burden share factor a between 0 and 1.

If the value of the corridor portion (V_{[STANDARD]-KA}) is subtracted from the value of the Absolute Standard License (V_{[STANDARD]-All}), the basic portion value (V_{[STANDARD]-GA}) is obtained. Thus, the value shares to be assigned are defined and calculable within the Absolute Standard License (V_{[STANDARD]-All}), expressed in one currency.

In order that the partial values V_{[STANDARD]-GA} and V_{[STANDARD]-KA} of the Absolute Standard License Value (V_{[STANDARD]-All}) can be divided and allocated pro rata to the portfolios of the various holders, the value of the portfolios for a standard must be determined according to the proposed calculation methodology partly at the level of the individual patents and partly at the level of the portfolio.

For the sake of better comprehensibility, the two levels will first be dealt with in general below. By linking the various databases into a global register database, the valuation algorithm knows all patents declared to be essential. Each registered SEP is assigned to a specific holder by means of a membership stamp. Since patents are in practice held by different companies within a group, it should also be possible to combine individual portfolios to form a group portfolio. This facilitates portfolio management and in turn saves transaction costs.

The basic prerequisite for the relevance of an individual patent to valuation is that it is in effect at the time of the valuation snapshot and is declared as essential for a technical standard. The total number of patents assigned to a specific owner, in force and declared to be essential forms the latter's total portfolio at the time of valuation. The overall portfolio of an owner in turn consists of sub-portfolios for the individual technical standards. The proposed valuation approach addresses this level of sub-portfolios. The added value of the sub-portfolios results in the value of the total portfolio of an owner. Individual patents may be included in more than one sub-portfolio if they have (rightly) been declared essential for more than one standard. The registered SEPs therefore have at least three attributes:
the territorial code of the SEP and its registration number ([TERR-CODE][REG-NUMBER]),
the standard membership of the SEP ([STANDARD]), depending on the technical standard for which an essentiality report was submitted, and
the current SEP holder ([OWNER]).

### #SEP=[TERR-CODE][REG-NUMBER][DEFAULT][OWNER]

### e.g. [EP][1222333][4G][NOKIA] or [US][1234567][4G][SONY]

It should already be noted at this point that at the level of the individual patent the determined and fixed legacy rank of the respective individual patent is recorded as an additional attribute.

The valuation algorithm works on three valuation levels:
(1) If the algorithm selects all SEPs registered in the database of a specific holder, the total portfolio of the selected holder is calculated as the sum S_{[OWNER]-All} (e.g. S_{[HUAWEI]-All}). The value of the total portfolio is the value V_{[OWNER]-All}.
(2) If the algorithm adds a certain technical standard to the selection of the holder, the partial portfolio of the selected holder for this standard results as the sum S_{[OWNER][STANDARD]-All}. (e.g. S_{[HUAWEI][4G]-All}). The value of this sub-portfolio is the value V_{[OWNER][STANDARD]-All}. If the values of the sub-portfolios are added, this naturally results in the value of the total portfolio V_{[OWNER]-All} (e.g. V_{[HUAWEI]-All}=V_{[HUAWEI][4G]-All}+V_{[HUAWEI][3G]-All}+V_{[HUAWEI][2G]-All}+V_{[HUAWEI][WIFI]-All}+V^{[HUAWEI][NFC]-All+ . . .} ).
(3) If, on the other hand, the algorithm only selects a certain standard, the patents declared essential for this standard result as the sum S_{[STANDARD]-All} (e.g. S_{[4G]-All}) regardless of their owner.

The owner-independent valuation level of the individual patent is of fundamental importance in two respects. On the one hand, worthless patents are identified at this level and excluded from further evaluation. On the other hand, the individual patent valuation is decisive for the division of the basic share (V_{[STANDARD]-GA}).

At the owner-independent valuation level of the individual patents, the sum S_{[STANDARD]-All} is divided into the shares S_{[STANDARD]-Rel} and S_{[STANDARD]-Fail}. Decisive evaluation criteria are the essentiality and legal validity of the respective patent.

For this purpose, the individual patents are assigned ranking order values—the values SEP-ER and SEP-VR. The value ER expresses the essentiality rank, a value between 0 and 5. The value VR expresses the validity rank, also a value between 0 and 5.

All patents declared essential for the selected standard (S_{[Standard]-All}) are subjected to this validity and essentiality test. The holistic view forms the basis for the applied top-down calculation approach. In contrast to contract negotiations, not only the SEP offered for license (usually only a selection of this SEP as a so-called “Proud List”) is checked against claim charts, but also all declared SEPs. It makes sense to use a valuation algorithm that either processes manually calculated values or—which is more obvious nowadays and causes less transaction costs—values determined by an AI-supported analysis.

However, a decisive criterion for the acceptance of the evaluation algorithm in practice is likely to be that decisions on legal status can also be fed in by specialist bodies, such as the European Patent Office (EPO) or the US Patent Trial and Appeal Board (PTAB). This should improve or worsen the SEP-VR legal standing of the patent affected by the decision. A modified scope of protection also requires a new Essentiality Assessment (SEP-ER), as the patent in question may no longer read to the selected standard.

Essentiality assessments could be supplemented by the assessment of expert committees and courts on a sample basis in order to review and improve the assessment algorithm. The Japanese Patent Office (JPO), for example, offers essentiality opinions.

If a patent declared to a standardization organization as essential for a standard is granted, the evaluation algorithm checks the questions of essentiality and validity for each declared patent and assigns the values SEP-ER and SEP-VR to the respective patent. The value 5 is the highest achievable value. The value 0 means in the respective context that the examined patent is not standard essential or not legally valid.

The ranking values determined in this way are multiplied to a patent-specific ranking value (SEP-W1):

$${( SEP - ER )}^{( 0 - 5 )} \times {( SEP - VR )}^{( 0 - 5 )} = {SEP - {W}_{1}}^{( 0 - 25 )}$$

The patent specific ranking value (SEP-W1) is an indicator of how strong the evaluated patent is in relation to other patents declared essential for the selected standard. This ensures that not all patents filed for a standard are assigned the same value as a whole, but that all patents are examined and weighted according to a uniform standard.

As a result of the ranking evaluation it may turn out that a patent declared as essential is either obviously not essential (SEP-ER=0) or obviously not legally valid (SEP-VR=0). It then receives a multiplier with the value 0, which inevitably results in a ranking value (SEP-W1) of 0. The patent is worthless and must therefore in principle be excluded from the evaluation mechanism. All patents with a SEP-W1 of 0 form the share S_{[STANDARD]-Fail}.

For further evaluation, the total number of patents S_{[STANDARD]-All} declared essential for the relevant standard is adjusted by the size S_{[STANDARD]-Fail} to S_{[STANDARD]-Rel}:

S_{[STANDARD]-All}−S_{[STANDARD]-Fail}=S_{[STANDARD]-Rel}

Only the share of patents with an actual value (S_{[STANDARD]-Ra})—no matter how small (e.g. SEP-W1=1)—is taken into account for the allocation of the basic share (V_{[STANDARD]-GA}).

The patents contained in the S_{[STANDARD]-Fail} share shall be assigned the value 0 irrespective of their holder. It should already be pointed out at this point that this division may also have an effect on the owner-dependent valuation. This is indicated below by the use of the attributes (Rel), (Fail) and (All) of the respective calculation factors.

The fixed legacy rank is awarded to each individual patent as an additional evaluation attribute. It dogmatically follows the valuation concept of “standard contributions” and is based on the consideration that companies that are particularly active in the further development of standardization generally apply for patents with higher value.

Since SEPs often prove to be invalid or non-essential in adversarial review, the Legacy Rank is intended to record the applicant's “DNA”. The rank forms a corrective for the evaluation by the algorithm (i.e. to the value SEP-W1).

The background for this valuation approach is that companies are increasingly filing patents and declaring them essential, even though they are hardly active in standardization or their contributions to standardization are not taken into account.

According to the simplest variation of this valuation approach, standardisation contributions can be taken into account by considering the total number of standardisation contributions of an enterprise for an entire standard (absolute consideration) or for a specific period of standardisation (sequential consideration, e.g. annually) individually or relative to the contributions of other enterprises.

A more precise overview of the quality of the standardisation contributions can be obtained if only the standardisation contributions actually accepted by the standardisation body are taken into account (so-called approved contributions). Only by accepting the contribution does the teaching of the patent application concerning the contribution become a technical imperative, i.e. a standard essential. However, this additional condition should be applied with caution, as the assumption of a contribution to standardisation in practice is not necessarily based solely on technical considerations, but may also depend on the skill and influence of the participant in the standardisation process.

If only the activity of a company in standardization is considered, however, no causal relationship is established between standardization contributions and patenting activity (“isolated” standard contributions approaches).

The closest qualitative link exists between (assumed) standardisation contributions and SEPs issued. However, despite the potential uncertainty arising from the fact that patent applications may be dropped for reasons other than lack of patentability during the examination procedure, the application figures are preferable to the grant figures. Because they are available immediately at the end of the year. The actual grant figures, on the other hand, are only available years later—partly after the peak of the standard implementation—and therefore only allow conclusions to be drawn for the past. They simply come too late for an efficient and fast calculation system.

The legacy rank should therefore be determined according to the valuation concept proposed here by linking logon numbers and standard contributions. For this purpose, a RankStandard_{Contributions} is created for each calendar year, which shows the annual Standard Contributions—determined by the standardization organizations (SSO)—in relation to patent applications declared as essential. Depending on the placement of the SEP applicant in the application year, a legacy rank SEP-LR between 0-10 is already assigned to the patents in the application year. This value can no longer be changed subsequently and therefore continues to exist even if the SEP holder changes.

The valuation level of the portfolio is used for the distribution of the corridor portion (V_{[STANDARD]-KA}). The calculation factors are all linked to the relative portfolio strength of the respective holders.

In the next step, the basic share (V_{[Standard]-GA}) of the Absolute Standard License (V_{[Standard]-All}) determined is to be distributed over the total number of essential patents contained in the number S_{[Standard]-Rel}. The value thus determined for the respective patent is the relative basic value of this patent (SEP-VGA).

If the value V_{[Standard]-GA} were simply divided by the number of patents contained in S_{[Standard]-Rel}, a purely numerical valuation concept would result—which would not do justice to the individual values of the patents (SEP-W1=1-25).

The patents contained in S_{[Standard]-Rel} are therefore to be sorted according to the respective individual values SEP-W1 and divided into rankings from RankW1 1 to RankW1 n. The patents are to be ranked according to the individual values SEP-W1. The result is a picture of the relative value ratios.

The value of RankW1 thus determines the proportional share of the individual patent in the standard basic share V_{[Standard]-GA}, its basic share value SEP-VGA.

### EXAMPLE

If, for example, 1,250 patents are declared essential for a standard (S_{[Standard]-All}), only 1,000 of them reach the minimum score of essentiality and validity (i.e. SEP-W1≥1) and thus belong to the number of S_{[Standard]-Rel}, i.e. S_{[Standard]-Rel}=1,000. These 1,000 individual patents can be awarded ranksW1 1 to 1,000, based on their values SEP-W1. Each patent would have a GA share (SEP-VGA) of 0.1% of the standard with linear calculation. If distributed according to the ranking, the patent with rankW1 1 would achieve a SEP VGA share of 0.19999%; the patent with rankW1 1000 would achieve a SEP VGA share of 0.0001%.

Patents belonging to the S_{[STANDARD]-Fail} group are assigned a SEP-VGA of 0. If all individual patents have been assigned a specific base value, the SEP portfolio of a specific holder for that standard (S_{[OWNER][STANDARD]-All}) can also be assigned a specific base value (V-GA_{[OWNER][STANDARD]-All}). It is calculated as the sum of the SEP-VGA of all the SEPs in the portfolio.

In addition, the average value W1 of the portfolio patents contained in S_{[OWNER][STANDARD]-All} is determined and expressed as the value “Portfolio-W1” (a value between 1-25).

The corridor share is an incentive to create patents that are as valuable as possible and to declare them essential in order to achieve the largest possible share of the corridor share V_{[STANDARD]-KA}. According to the comparative market concept, a patent holder with a stronger, i.e. valuable, portfolio can achieve higher royalties on the market. The corridor portion proposed therefore serves to promote competition within a standard and investment in the quality of portfolio patents.

In contrast to the share of an essential patent in the basic value (SEP-VGA), the share of an essential patent in the corridor value (SEP-VKA) is therefore calculated on the basis of portfolio membership and thus on the relative portfolio strength of each holder (V_{[OWNER][STANDARD]-All}). This results in the immediate value V-KA_{[OWNER][STANDARD]-All}. The value V-KA_{[OWNER][STANDARD]-All} can again—if desired—be allocated to the individual portfolio patents of the holder at the individual patent values SEP-VKA. Since the relative portfolio strength is fed by all valuable portfolio patents (S_{[OWNER][STANDARD]-Rel}), a linear distribution of the value V-KA_{[OWNER][STANDARD]-All} to the patents contained in S_{[OWNER][STANDARD]-Rel} appears appropriate. The patents contained in S_{[OWNER][STANDARD]-Fail} are again disregarded in the value allocation.

In order to assign the corridor share value V_{[STANDARD]-KA} to the portfolios of the individual holders, each portfolio of a specific holder is assigned a specific portfolio score for a specific standard (i.e. S_{[OWNER][STANDARD]-All}), the score portfolio_{[OWNER][STANDARD]-KA}.

Portfolio_{[OWNER][STANDARD]-KA}(2-120)=Portfolio-W1 (0-25)×Portfolio-W2 (1-4)+Portfolio-W3 (0-10)+Portfolio-W4 (0-10)

The score portfolio_{[OWNER][STANDARD]-KA} is in turn determined by certain valuation factors that are determined for the portfolio. Four valuation factors, the values Portfolio-W1 to Portfolio-W4, are proposed here as examples, which should have the following relationship to each other: The individual valuation factors are determined as follows: The value Portfolio-W1 follows on from the preparatory work of the algorithm for allocating the base unit value (V_{[STANDARD]-GA}). There, an individual value SEP-W1 between 1 and 25 was assigned to each individual patent on the basis of the legal status and essentiality assessment. For the value Portfolio-W1, the average value W1 of the portfolio patents contained in S_{[OWNER][STANDARD]-All} for a specific holder and a specific standard is calculated and also expressed as the (then average) value between 0 and 25.

For the average value, conscious reference should not be made to the sum of the patents S_{[OWNER][STANDARD]-Rel} which retain their value, but to the sum of all patents declared to be essential. Because the share S_{[OWNER][STANDARD]-Fail} with the value W1=0 does not increase the counter when calculating the average, but the patent nevertheless appears in the denominator, the average value Portfolio-W1 decreases proportionately. This sanctions over-declaration and creates an incentive for SEP holders to invest in consistently high patent quality and in any case not to deliberately report patents as essential.

The value Portfolio-W2 is a multiplier between 1 and 4, through which the numerical size of the portfolio to be licensed is included in the valuation. This is necessary because smaller patent portfolios can more easily achieve a high average portfolio W1—which in turn would create an incentive to group the most valuable patents into highly valued micro-portfolios in order to participate as generously as possible in the corridor share value.

The Portfolio-W2 multiplier is intended to counteract such a strategic consideration from the outset. Large portfolios that nevertheless achieve a high portfolio value W1—because they achieve above-average quality with low/moderate over-declaration—are thus valued. If the portfolio owner transfers a large number of high-quality patents, for example to an NPE, he is threatened with the (at least proportionate) loss of his right to the corridor value share because his portfolio W1 and portfolio W2 values deteriorate. Even if he can realise higher royalties in individual cases through the use of an NPE, the economic impact on his own portfolio (loss of quality and thus value) is likely to erode this profit.

The value Portfolio-W2 should be a multiplier between 1 and 4, whereby the value 4 should be reserved for the licensors with the largest portfolios and also the multipliers 2 and 3 should not be assigned lightly. Finally, in individual cases this leverage can mean a drastic improvement of the score portfolio_{[OWNER] [STANDARD]-KA} and thus significantly increase the chance that the SEP holder concerned may participate in the corridor value share V_{[STANDARD]-KA} In the area of mobile communications, for example, this could apply (in relation to SEP issued, not families):

| | | | |
|---|---|---|---|
| Portfolio | up to 1.000 SEP | Portfolio | 3,000 to 6,000 SEP |
| W2 = 1 | | W2 = 3 | |
| Portfolio | 1,000 to 3,000 SEP | Portfolio | from 6.000 SEP |
| W2 = 2 | | W2 = 4 | |

The value Portfolio-W3 takes into account the origin of the portfolio patents and is based on their average legacy rank (SEP-LR). For the value Portfolio-W3, the average value SEP-LR between 0 and 10 is calculated for a certain holder and a certain standard. This means that the sum of the portfolio patents contained in the portfolio (S_{[OWNER][STANDARD]-Rel}) can be assigned an (average) value between 0 and 10.

In contrast to the value Portfolio-W1, the average value Portfolio-W3 should deliberately not refer to the sum of all patents S_{[OWNER][STANDARD]-All}, but only to the sum of all patents S_{[OWNER][STANDARD]-Rel}. This ensures that ineligible patents from the share S_{[OWNER][STANDARD]-Fail}, i.e. with a value W1 of 0, do not influence the average legacy rank SEP-LR when calculating the average. Otherwise, the average SEP-LR could be artificially influenced by non-legally binding and/or non-essential patents of companies active in standardisation, despite their worthlessness.

The value Portfolio-W4 takes into account the territorial extension of the SEP portfolio offered for licensing and is therefore comparable to the “regional strength ratio” mentioned by Judge Selna in TCL v Ericsson. The value Portfolio-W4 is a value between 0 and 10 that territorially weights the portfolio patents contained in S_{[OWNER][STANDARD]-Rel} for a specific holder and standard.

Once the valuation algorithm has determined the Portfolio-W1 to Portfolio-W4 valuation factors, it can calculate the Score Portfolio_{[OWNER][STANDARD]-KA} for each individual patent holder who is the holder of at least one essential patent to the rated standard according to the formula shown above.

Subsequently, the relative portfolio strength ratios for the standard are determined by the global comparison of the scores achieved Portfolio_{[OWNER][STANDARD]-KA} and reflected by the rank_{[STANDARD][OWNER]-KA}.

Only the portfolios with the highest rank_{[STANDARD][OWNER]-KA}, for example the five or ten best rated portfolios, participate in the value V_{[STANDARD]-KA}. The value of the rank_{[STANDARD][OWNER]-KA} thus determines the proportional share of the individual portfolios in the value of V_{[STANDARD]-KA}, their concrete corridor value share (V-KA_{[OWNER][STANDARD]-All}).

The dogmatic justification for this is that these portfolios would achieve a higher price in quality-based contract negotiations. For this reason, it must also be ensured that the Rank_{[STANDARD]-KA} does not only gain access to the corridor share value V_{[STANDARD]-KA} through a relative value ratio, but that the portfolio has exceeded an objective value limit, e.g. a score portfolio_{[OWNER][STANDARD]-KA} of more than 40. If the score portfolio_{[OWNER][STANDARD]-KA} is less than or equal to 40, there can be no question of a valuable portfolio. This means that access to the corridor share value V_{[STANDARD]-KA} has the cumulative prerequisite that a sufficiently high (relative) rank_{[STANDARD][OWNER]-KA} and at the same time a sufficiently high (absolute) score portfolio_{[OWNER][STANDARD]-KA} are achieved.

Portfolios that do not meet these requirements only participate in the basic unit value V_{[STANDARD]-GA}. If, as a result, the corridor share value V_{[STANDARD]-KA} cannot be fully distributed among SEP holders, this should not result in the share of SEP holders whose portfolios have qualified for the corridor share value V_{[STANDARD]-KA} increasing automatically. This is because the corridor share value is basically intended to reward individual quality and would then possibly lead to (possibly random) overcompensation of individual SEP holders. If the corridor share value V_{[STANDARD]-KA} is not fully exhausted, the maximum license fee to be paid by the standard implementers decreases.

As outlined above, the value V-KA_{[OWNER][STANDARD]-All} can in principle be distributed linearly over the portfolio patents of the SEP holder of the S_{[OWNER][STANDARD]-Rel} category. From this the value SEP-VKA is calculated for these patents. The SEP-VKA of the patents contained in S_{[OWNER][STANDARD]-Fail} remains “0”—as is the case for patents whose holders have not qualified for the corridor value portion. The addition of the individual values SEP-VGA and SEP-VKA results in the value of the individual SEP (SEP-V) at the valuation point, expressed in one currency.

The added values V-GA_{[OWNER][STANDARD]-All} and V-KA_{[OWNER][STANDARD]-All} result in the total license for the SEP holder's portfolio for the verified standard at the Valuation Point, expressed in one currency—V_{[OWNER][STANDARD]-All}.

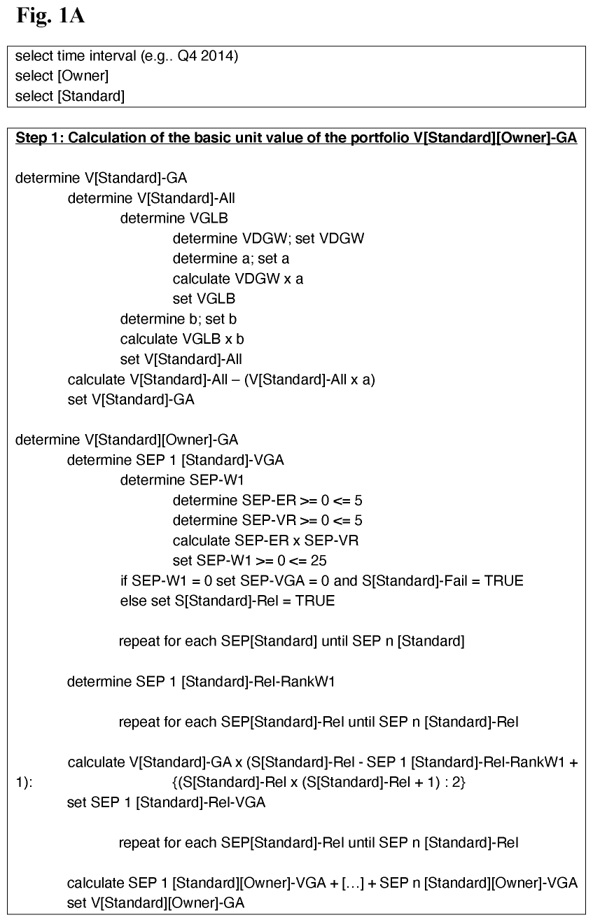

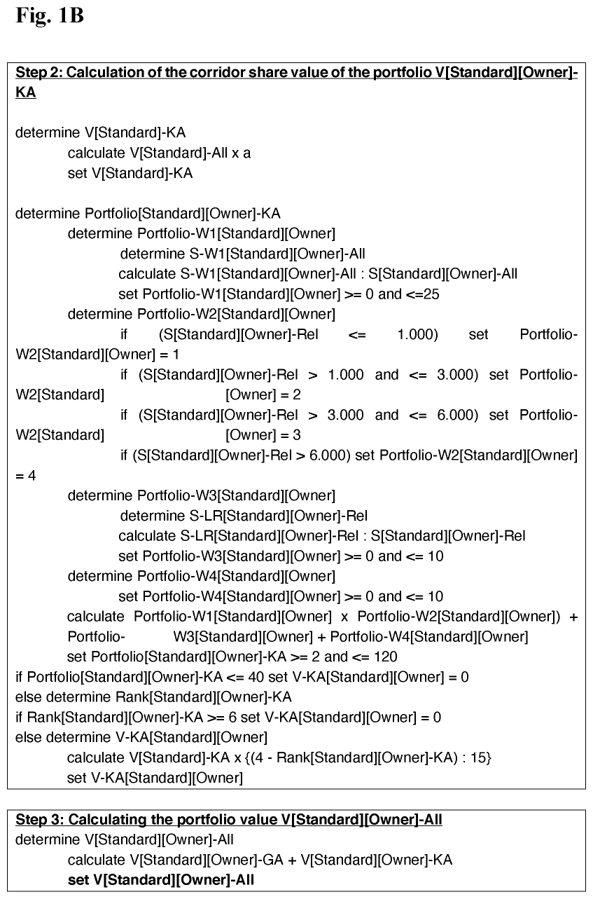

The functioning of the calculation methodology proposed here is illustrated below as an example for a portfolio license (V[Standard][Owner]-All) and a single SEP Y (SEP Y-V). The formulas are not represented in a specific programming language, but as chains of work steps. An example, how the value of a portfolio license (V[Standard][Owner]-All) could be calculated is shown in FIG. 1.

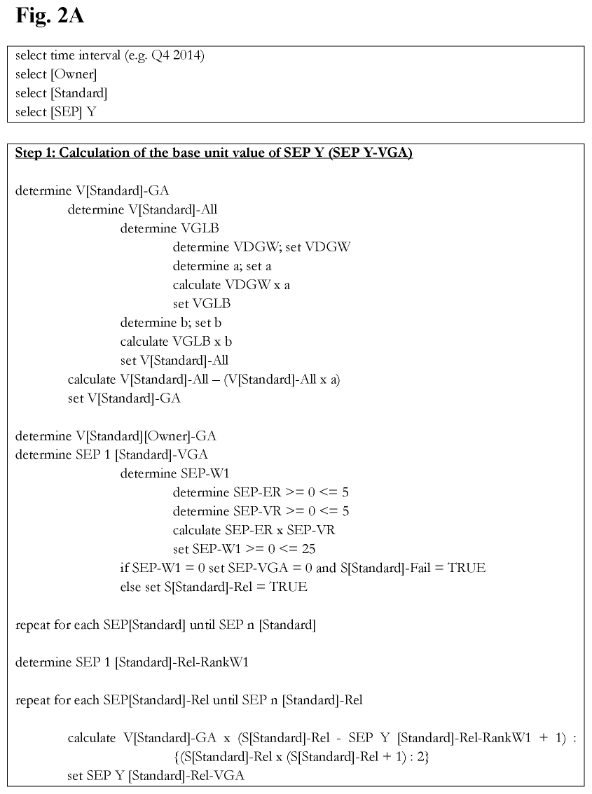

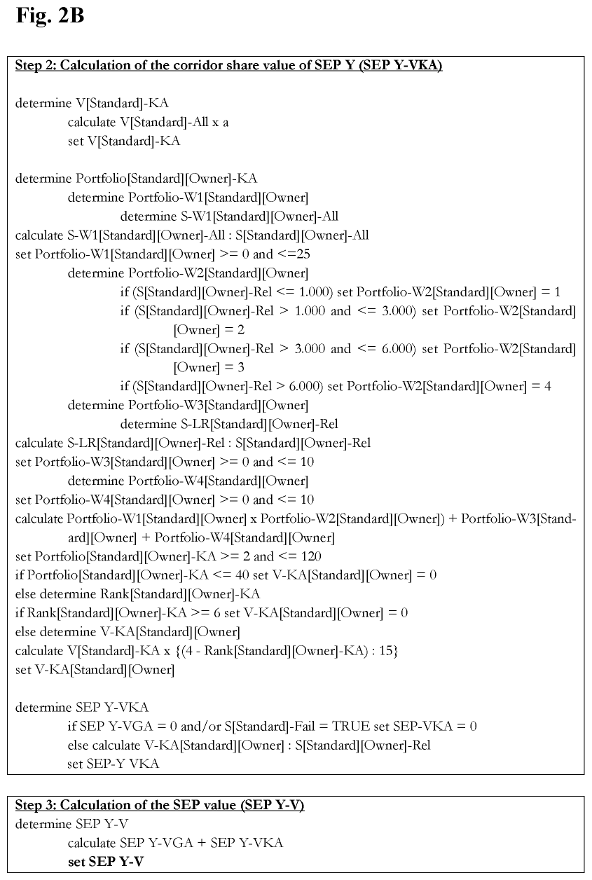

An example, how the value of a single SEP Y (SEP Y-V) could be calculated is shown in FIG. 2.

This enables the license owed during the valuation interval for the use of the SEP portfolio of a specific holder to be specifically determined, reproduced as a unit license amount in a specific currency, and finally settled.

If the licensed object is produced and distributed by several companies in a (usually global) value-added and distribution chain, the question may arise in practice where and how the calculated royalty arises within the value-added chain. This is because every economic operator within a value chain has its own right to access the result of standardisation by granting a license under FRAND conditions.

If one understands the exploitation chain as a unit within which the fee is incurred only once—but in full at each stage and with an “exhaustion” effect under antitrust law —, the passing cost item and the extent of the effect of the payment of the fee could be recorded automatically and stored in the blockchain in a counterfeit-proof manner. In practice, for example, the defence argument could be substantiated in an infringement suit that concrete challenged embodiments were lawfully produced and/or marketed with the consent of the owner of the intellectual property right.

If the exploitation chain is also stored in the system, double payments within the exploitation chain could be reliably excluded in the future and a recourse mechanism or distribution key for the license fee could be provided for within the exploitation chain. It is conceivable, for example, to break it down according to value added shares.

The calculation example shows which steps the valuation algorithm could follow and how in individual cases a portfolio license fee and the value of an individual patent could be calculated. The portfolio royalty owed is the amount accrued for a specified time interval for the worldwide use of the SEP portfolio of a specified holder for a specified standard. The value of the individual SEP is only a summand. Nevertheless, the fundamental possibility of assigning a concrete monetary value to a SEP for a certain period of time in practice opens up a bouquet of further economic exploitation possibilities for the SEP concerned. Licensing is only an economic possibility of exploitation.

The presented evaluation mechanism's decisive advantage, is that it is legally and technically feasible with today's equipment and does not have to remain an academic utopia. In the meantime, technical development has progressed so far that self-executing contracts can operate independently on the basis of databases, which in turn are forgery-proof through the use of block-chain technology and approach the status of a public register. The transparency and flexibility created by these technologies is particularly beneficial for SMEs, which, due to the low transaction costs, achieve a better contractual result than they could in real contract negotiations with their limited resources. In addition, the high level of detail of the evaluation mechanism (granularity of consideration) creates new possibilities for exploiting individual patents—e.g. use as collateral for loans—and improves or maintains the marketability of SEP despite the binding nature of the FRAND commitment.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

While the present invention has been described with reference to one or more preferred embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention.

In the foregoing specification, the invention has been described with reference to specific examples of embodiments of the invention. It will, however, be evident that various modifications and changes may be made therein without departing from the broader spirit and scope of the invention as set forth in the appended claims.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

Any reference to “having”, “including” or “comprising” should be applied mutatis mutandis to “consisting” and/or “consisting essentially of”

What is claimed is:

1. A method of operating an apparatus that is configured to manage a licensable item, comprising:
determining a first fair and reasonable license term and a second fair and reasonable license term;
accessing a licensing policy related to whether an action is permitted to be taken with the licensable item and if said action is in accord with said first fair and reasonable license term and in accord with said second fair and reasonable license term, and wherein the licensing policy corresponds to a client version of a license for the licensable item that is maintained on the apparatus and is configured to be synchronized with a server version of the license for the licensable item that is maintained on a server; making a determination, by a license agent, first attempt to communicate, by the apparatus, with the server in order to synchronize the client and server versions of the license before acting to enforce the licensing policy for the action;
attempting to communicate, by the apparatus, with the server in order to synchronize the client and server versions of the license before acting to enforce the licensing policy for the action in response to the determination to first attempt to communicate with the server in order to synchronize the client and server versions of the license before acting to enforce the licensing policy for the action, wherein synchronization of the client and server versions of the license produces a synchronized client version of the license by updating the client version of the license to include one or more changes made to one or more licensing policies in the server version of the license that occurred after a previous synchronization of the client version of the license with the server version of the license; and
enforcing the licensing policy for the action based on the non-synchronized version of the license in response to the attempt to communicate by the apparatus with the server being unsuccessful, wherein accessing the licensing policy includes accessing a first licensing policy related to a first licensable item in a first runtime and accessing a second licensing policy related to a second licensable item in a second runtime, and wherein enforcing the licensing policy includes enforcing the first licensing policy for the first licensable item executed in the first runtime and enforcing the second licensing policy for the second licensable item executed in the second runtime, and then making available said server versions of the license available to third party databases for transacting commercial activity including buying and selling said server versions of said license and providing licenses pertaining to said server versions of said licenses to third parties and in turn payment for said licenses to holders said server versions of said licenses.

2. The method of claim 1, wherein accessing the licensing policy includes accessing an enforcement rule associated with the licensing policy, and wherein enforcing the licensing policy includes determining a constraint imposed by the enforcement rule on the action taken with the licensable item.

3. The method of claim 1, wherein the action is providing a license to a third party in response to a device controlled by said third party automatically requesting said license.

4. The method according to claim 1, wherein the server version of the license is maintained as a record on the basis of distributed ledger technology.

5. The method according to claim 2, wherein the server version of the license is maintained as a record on the basis of distributed ledger technology.

6. The method according to claim 3, wherein the server version of the license is maintained as a record on the basis of distributed ledger technology.

7. An apparatus for managing a licensable item, comprising:
at least one processing circuit configured to:
access a licensing policy related to whether an action is permitted to be taken with the licensable item, wherein the licensing policy corresponds to a client version of a license for the licensable item that is maintained on the apparatus and is configured to be synchronized with a server version of the license for the licensable item that is maintained on a server;
make a determination to first attempt to communicate with a server in order to synchronize the client and server versions of the license before acting to enforce the licensing policy for the action;
attempt to communicate with a server in order to synchronize the client and server versions of the license before acting to enforce the licensing policy for the action in response to the determination to first attempt to communicate with a server in order to synchronize the client and server versions of the license before acting to enforce the licensing policy for the action, wherein synchronization of the client and server versions of the license produces a synchronized client version of the license by updating the client version of the license to include one or more changes made to one or more licensing policies in the server version of the license that occurred after a previous synchronization of the client version of the license with the server version of the license; and
enforce the licensing policy for the action based on the non-synchronized version of the license in response to the attempt to communicate by the apparatus with a server being unsuccessful, wherein the at least one processing circuit is configured to access the licensing policy by accessing a first licensing policy related to a first licensable item in a first runtime and accessing a second licensing policy related to a second licensable item in a second runtime, and wherein the at least one processing circuit is configured to enforce the licensing policy by enforcing the first licensing policy for the first licensable item executed in the first runtime and enforcing of the second licensing policy for the second licensable item executed in the second runtime, and wherein first and second fair and reasonable license terms are established and included within said server versions of said licenses.

8. The apparatus according to claim 7, wherein the licensing policy includes accessing an enforcement rule associated with the licensing policy, and wherein enforcing the licensing policy includes determining a constraint imposed by the enforcement rule on the action taken with the licensable item.

9. The apparatus of claim 7, wherein a license is provided to a third party in response to a device controlled by said third party automatically requesting said license.

10. The apparatus according to claim 7, wherein the server version of the license is maintained as a record on the basis of distributed ledger technology.

11. The apparatus according to claim 8, wherein the server version of the license is maintained as a record on the basis of distributed ledger technology.

12. The apparatus according to claim 9, wherein the server version of the license is maintained as a record on the basis of distributed ledger technology.
